(19) United States
(12) Patent Application Publication
(10) Pub. No.: US 2021/0312477 A1
(43) Pub. Date: Oct. 7, 2021

(54) ANALYZER, ANALYSIS METHOD, INFORMATION PROCESSING DEVICE, AND INFORMATION PROCESSING METHOD

(71) Applicant: KDDI CORPORATION, Tokyo (JP)

(72) Inventors: Kenjirou KANDA, Tokyo (JP); Kenji NISHIURA, Tokyo (JP)

(73) Assignee: KDDI CORPORATION, Tokyo (JP)

(21) Appl. No.: 17/266,691

(22) PCT Filed: Sep. 18, 2019
(86) PCT No.: PCT/JP2019/036590

§ 371 Date: Feb. 8, 2021

(30) Foreign Application Priority Data
Sep. 25, 2018 (JP) 2018-178837
Sep. 25, 2018 (JP) 2018-178838

(51) Int. Cl. G06Q 30/02; G06Q 30/06; H04W 4/029; H04W 4/80

(52) U.S. Cl. CPC G06Q 30/0201; G06Q 30/0639; H04W 4/80; H04W 4/029; G06Q 30/0205

(57) ABSTRACT

According to an embodiment of the present invention, an analysis server includes an in-site location information acquisition unit configured to acquire first location information indicating a location of a terminal that is measured when the terminal of a user is connected to a plurality of location measurement devices installed inside a prescribed site in association with in-site identification information for identifying the user or the terminal, an off-site location information acquisition unit configured to acquire second location information indicating a location of the terminal measured in a measurement method different from that of the first location information outside the site in association with off-site identification information for identifying the user or the terminal, an analysis unit configured to associate the first location information with the second location information by associating the in-site identification information with the off-site identification information and analyze the first location information and the second location information that have been associated, and an output unit configured to output analysis results.

### TECHNICAL FIELD

The present invention relates to an analyzer, an analysis method, an information processing device, and an information processing method for analyzing location information and/or payment information of a communication terminal.

Priority is claimed on Japanese Patent Application Nos. 2018-178837 and 2018-178838, filed Sep. 25, 2018, the contents of which are incorporated herein by reference.

### BACKGROUND ART

Conventionally, time-series changes (i.e., flow lines) in locations of users have been analyzed to promote visits of users to shops or purchases of products (see, for example, Patent Document 1). By analyzing flow lines of users, a business operator can estimate types of products in which the users are interested.

### PRIOR ART DOCUMENT

### Patent Document

### [Patent Document 1]

Japanese Patent No. 5967553

### SUMMARY OF INVENTION

### Problems to be Solved by the Invention

Incidentally, a location of a user outside a shop and a location of a user inside a shop may be managed by different business operators. For example, a certain business operator measures a location of a user outside a shop using a Global Positioning System (GPS) with a wide coverage. Another business operator measures a location of a terminal of a user inside the shop using short-range wireless communication of a wireless local area network (LAN), Bluetooth (registered trademark), or the like for which equipment is easily installed indoors. In this case, each business operator has no choice but to analyze only a location of a user managed by itself and it is difficult to consistently analyze locations of a user inside and outside a shop.

Also, location information indicating a location of a user and payment information when the user purchases a product or a service are independent of each other. Thus, it is necessary to associate the location information and the payment information of the same user so that the location information and the payment information are able to be analyzed. Significant time and effort for the user or the operator to manually associate the location information and the payment information are required.

The present invention has been made in view of the above-described circumstances and an object of the present invention is to provide an analyzer and an analysis method capable of consistently analyzing locations of a user inside and outside a site such as a shop.

Further, the object of the present invention is to provide an information processing device and an information processing method capable of reducing the time and effort required for analyzing location information and payment information of a user in a shop.

### Means for Solving the Problems

According to a first aspect of the present invention, there is provided an analyzer including: a first acquisition unit configured to acquire first location information indicating a location of a terminal that is measured when the terminal of a user is connected to a plurality of location measurement devices installed inside a prescribed site in association with in-site identification information for identifying the user or the terminal; a second acquisition unit configured to acquire second location information indicating a location of the terminal measured in a measurement method different from that of the first location information outside the site in association with off-site identification information for identifying the user or the terminal; an analysis unit configured to associate the first location information with the second location information by associating the in-site identification information with the off-site identification information and analyze the first location information and the second location information that have been associated; and an output unit configured to output analysis results.

The first acquisition unit may acquire the first location information indicating the location of the terminal that is measured when the terminal is connected to a plurality of location measurement devices through short-range wireless communication.

The first acquisition unit may acquire a route along which the terminal has moved inside the site as the first location information.

The second acquisition unit may acquire a route along which the terminal has moved outside the site as the second location information.

The first acquisition unit may acquire a location of the terminal inside the site and a time when the location has been measured as the first location information and the second acquisition unit may acquire a location of the terminal outside the site and a time when the location has been measured as the second location information.

The analysis unit may statistically analyze the first location information and the second location information of a plurality of users for each attribute of the plurality of users.

The analysis unit may estimate a product or a service in which the user is interested on the basis of the first location information and the output unit may transmit information associated with the product or the service estimated by the analysis unit to the terminal.

The first acquisition unit may acquire the first location information indicating a location of the terminal inside the site including a plurality of shops.

The first acquisition unit may acquire the first location information indicating a location of the terminal that is measured when the terminal is connected to a plurality of location measurement devices installed within the plurality of shops or between shops.

The analysis unit may identify a site visited by the user outside the site on the basis of the second location information.

The analysis unit may statistically analyze information about a location where the user has stayed for a prescribed time period or longer on the basis of the second location information.

The first acquisition unit may acquire the in-site identification information that the location measurement device has acquired from the terminal by receiving the in-site identification information from the location measurement device.

According to a second aspect of the present invention, there is provided an analysis method performed by a processor, including steps of: acquiring first location information indicating a location of a terminal that is measured when the terminal of a user is connected to a plurality of location measurement devices installed inside a prescribed site in association with in-site identification information for identifying the user or the terminal; acquiring second location information indicating a location of the terminal measured in a measurement method different from that of the first location information outside the site in association with off-site identification information for identifying the user or the terminal; associating the first location information with the second location information by associating the in-site identification information with the off-site identification information and analyzing the first location information and the second location information that have been associated; and outputting analysis results.

According to a third aspect of the present invention, there is provided an information processing device including: a location information acquisition unit configured to acquire location information indicating a location of a user terminal that is measured when the user terminal owned by a user is connected to a plurality of location measurement devices installed inside a prescribed site including a shop in association with first identification information for identifying the user or the user terminal; a payment information acquisition unit configured to acquire payment information indicating content of payment processed in association with second identification information for identifying the user or the user terminal in the shop and performed by the user using the user terminal; and an output unit configured to output information generated by associating the location information with the payment information when the first identification information associated with the location information is associated with the second identification information associated with the payment information.

The payment information acquisition unit may acquire the payment information indicating the content of the payment performed by reading a code indicating information associated with the second identification information displayed by the user terminal using a shop terminal installed in the shop.

The information processing device may further include a payment processing unit configured to cause a display unit of a shop terminal installed in the shop to display a code indicating information associated with the shop or the payment, wherein the payment information acquisition unit may acquire the payment information indicating the content of the payment performed by the user terminal reading a code indicating information associated with the shop or the payment.

When the first identification information associated with the location information is the same as the second identification information associated with the payment information or when the first identification information associated with the location information is associated with the second identification information associated with the payment information in a storage unit, the output unit may output information generated by associating the location information with the payment information.

The output unit may acquire the first identification information associated with the second identification information in the storage unit after acquiring the second identification information associated with the payment information and associate the location information associated with the first identification information that has been acquired with the payment information associated with the second identification information that has been acquired.

The location information acquisition unit may acquire a location of the user terminal inside the site and a time when the location has been measured as the location information.

The information processing device may further include an analysis unit configured to estimate a product or a service in which the user is interested on the basis of the location information and the payment information, wherein the output unit may transmit information associated with the product or the service estimated by the analysis unit to the user terminal.

The payment information acquisition unit may acquire the payment information indicating at least one of a name of a product or a service purchased by the user, the amount of money of the payment, and identification information of the shop where the user has purchased the product or the service.

The location information acquisition unit may acquire the location information indicating a location of the user terminal inside the site including a plurality of shops.

The output unit may output information generated by associating the location information with the payment information in the plurality of shops.

The output unit may output information about a shop that has not been visited by the user among the plurality of shops on the basis of the location information.

The output unit may output benefits available for payment, which is performed by the user using the user terminal, to the user terminal on the basis of the location information and the payment information.

According to a fourth aspect of the present invention, there is provided an information processing method performed by a processor, including steps of: acquiring location information indicating a location of a user terminal that is measured when the user terminal of a user is connected to a plurality of location measurement devices installed inside a prescribed site including a shop in association with first identification information for identifying the user or the user terminal; acquiring payment information indicating content of payment processed in association with second identification information for identifying the user or the user terminal in the shop and performed by the user using the user terminal; and outputting information generated by associating the location information with the payment information when the first identification information associated with the location information is associated with the second identification information associated with the payment information.

### Advantageous Effects of the Invention

According to an embodiment of the present invention, it is possible to consistently analyze locations of a user inside and outside a site such as a shop.

Further, according to an embodiment of the present invention, it is possible to reduce the time and effort required for analyzing location information and payment information of a user in a shop.

### BRIEF DESCRIPTION OF DRAWINGS

FIG. 1 is a schematic diagram showing an analysis system according to a first embodiment.

FIG. 2 is a schematic diagram showing an analysis method executed by the analysis system according to the first embodiment.

FIG. 3 is a block diagram showing an analysis system according to the first embodiment.

FIG. 4 is a front view showing a communication terminal displaying a registration screen for registering user information in the first embodiment.

FIG. 5 is a schematic diagram showing off-site location information and in-site location information acquired by an analysis server in the first embodiment.

FIG. 6 is a schematic diagram showing a flow line of a communication terminal outside a site indicated by off-site location information in the first embodiment.

FIG. 7 is a schematic diagram showing a flow line of a communication terminal inside the site indicated by in-site location information in the first embodiment.

FIG. 8A is a front view showing a communication terminal displaying a product as an analysis result of an analysis unit in the first embodiment.

FIG. 8B is a front view showing a communication terminal displaying a shop as an analysis result of the analysis unit in the first embodiment.

FIG. 9 is a sequence diagram showing an analysis method executed by the analysis system according to the first embodiment.

FIG. 10 is a schematic diagram showing an analysis system according to a second embodiment.

FIG. 11 is a schematic diagram showing an analysis method executed by the analysis system according to the second embodiment.

FIG. 12 is a block diagram showing an analysis system according to the second embodiment.

FIG. 13 is a front view showing a user terminal displaying a registration screen for registering user information in the second embodiment.

FIG. 14 is a schematic diagram showing location information and payment information acquired by a shop server in the second embodiment.

FIG. 15 is a schematic diagram showing a flow line of a user terminal inside a site indicated by location information in the second embodiment.

FIG. 16 is a front view showing a user terminal displaying analysis results of an analysis unit in the second embodiment.

FIG. 17 is a sequence diagram showing an analysis method executed by an analysis system according to the second embodiment.

FIG. 18A is a schematic diagram showing a payment process when a user terminal displays a code in the analysis system according to the second embodiment.

FIG. 18B is a schematic diagram showing a payment process when a shop terminal displays a code in the analysis system according to the second embodiment.

FIG. 19 is a sequence diagram showing a payment process when the user terminal displays a code in the second embodiment.

FIG. 20 is a sequence diagram showing a payment process when the shop terminal displays a code in the second embodiment.

FIG. 21 is a sequence diagram showing another payment process when the shop terminal displays a code in the second embodiment.

### EMBODIMENTS FOR CARRYING OUT THE INVENTION

### [Overview of Analysis System 1S]

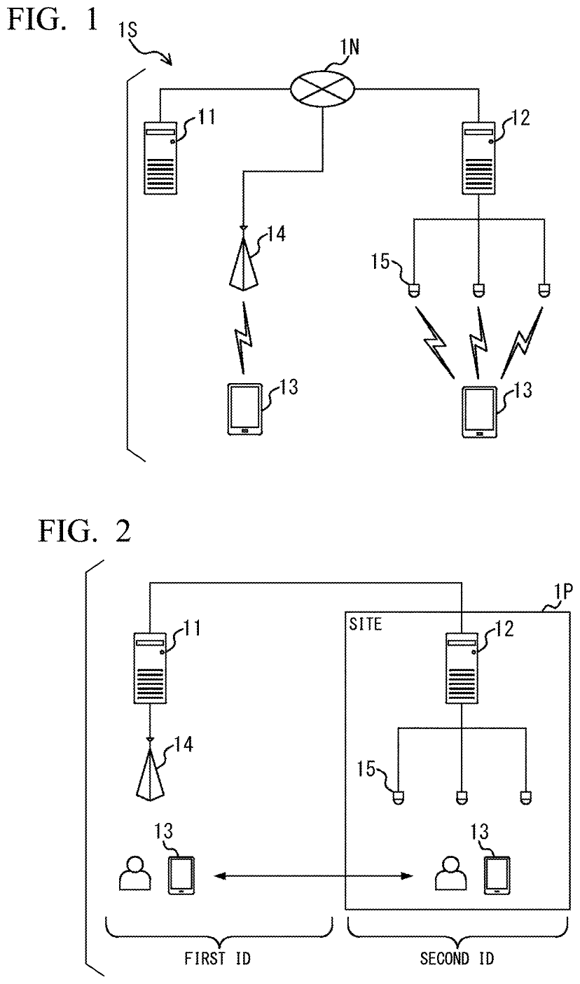

FIG. 1 is a schematic diagram of an analysis system 1S according to a first embodiment. The analysis system 1S includes an analysis server 11, a shop server 12, and a communication terminal 13. The analysis system 1S may include equipment such as other servers and terminals.

The analysis server 11 (an analyzer) is a computer that acquires and analyzes the location information of the communication terminal 13. The analysis server 11 acquires location information of the communication terminal 13 outside a site such as a shop via a base station 14 installed outside the site. In addition to this, the analysis server 11 acquires location information of the communication terminal 13 inside the site transmitted from the shop server 12. Further, the analysis server 11 associates the acquired location information inside and outside the site, analyzes the associated location information, and outputs analysis results.

The shop server 12 (an information processing device) is a computer that acquires the location information of the communication terminal 13. The shop server 12 acquires the location information of the communication terminal 13 inside the site using a beacon 15 installed inside the site. The shop server 12 transmits the location information of the communication terminal 13 outside the site to the analysis server 11 via a network 1N such as the Internet or a LAN.

The communication terminal 13 (a communication device) is a computer capable of performing communication. For example, the communication terminal 13 is a smartphone, a portable terminal such as a tablet terminal, or a personal computer. The communication terminal 13 includes a communication unit for performing mobile communication of Long Term Evolution (LTE) or the like and short-range wireless communication of Bluetooth, a wireless LAN, or the like. Also, the communication terminal 13 includes a display unit such as a liquid crystal display for displaying various information.

FIG. 2 is a schematic diagram of an analysis method executed by the analysis system 1S according to the first embodiment. The user having the communication terminal 13 moves inside and outside the site 1P such as a shop. The site 1P may be a site (a building or land) of one shop or may be a site of a complex of a plurality of shops such as a shopping center or a department store.

The communication terminal 13 measures a location (for example, latitude and longitude) of the communication terminal 13 outside the site 1P using a GPS or the like. For example, the communication terminal 13 periodically receives a GPS signal outside the site 1P and measures the location of the communication terminal 13. The communication terminal 13 transmits the location of the communication terminal 13 outside the site 1P to the analysis server 11 via the base station 14 in association with a first ID (off-site identification information) serving as identification information for identifying the communication terminal 13 or the user. For example, the first ID is assigned and managed by a communication carrier that operates a communications service using the base station 14.

A plurality of beacons 15 are installed at different locations inside the site 1P. When the site 1P includes a plurality of shops, the beacons 15 may be installed inside the plurality of shops or the beacons 15 may be installed between the plurality of shops. Also, one beacon 15 may be installed in each of the plurality of shops. The beacon 15 is a location measurement device that can be connected to the communication terminal 13 through short-range wireless communication of Bluetooth, a wireless LAN, or the like. For example, when the user enters the site 1P, the communication terminal 13 is connected to the beacon 15 through short-range wireless communication. The shop server 12 measures the location of the communication terminal 13 inside the site on the basis of the location of the beacon 15 to which the communication terminal 13 is connected. The shop server 12 transmits the location of the communication terminal 13 inside the site 1P to the analysis server 11 in association with a second ID (in-site identification information) serving as the identification information for identifying the communication terminal 13 or the user. For example, the shop server 12 may associate the location with the second ID by assigning the second ID to data of the location or may assign common identification information (a transaction ID or the like) to data of the location and data of the second ID. For example, the second ID is assigned and managed by a shop business operator who operates a shop inside the site 1P.

By associating the first ID with the second ID, the analysis server 11 associates the location of the communication terminal 13 outside the site 1P acquired from the communication terminal 13 with the location of the communication terminal 13 inside the site 1P acquired from the shop server 12. The analysis server 11 analyzes locations of the communication terminal 13 inside and outside the site 1P associated with each other, and outputs analysis results.

As described above, the analysis system 1S associates the first ID for identifying the communication terminal 13 or the user outside the site 1P with the second ID for identifying the communication terminal 13 or the user inside the site 1P. Thus, the analysis system 18 can consistently analyze the locations of the communication terminal 13 measured in different measurement methods inside and outside the site 1P such as a shop or the like.

### [Configuration of Analysis System 1S]

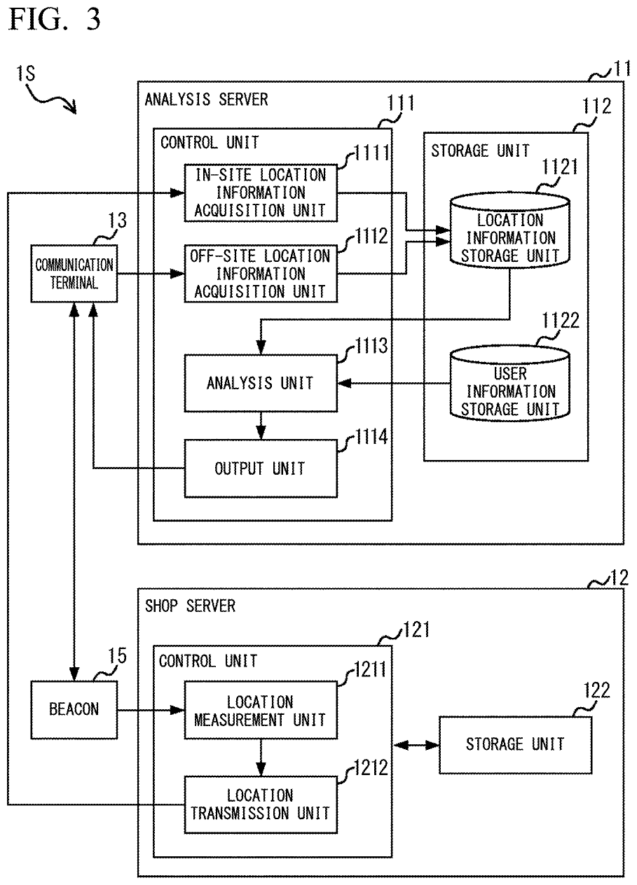

FIG. 3 is a block diagram of the analysis system 1S according to the first embodiment. In FIG. 3, arrows indicate main data flows. There may be data flows other than those shown in FIG. 3. In FIG. 3, each block shows a functional unit configuration instead of a hardware (device) unit configuration. Thus, the blocks shown in FIG. 3 may be implemented within a single device or may be implemented separately within a plurality of devices. Data may be transmitted and received between blocks via any means such as a data bus, a network, or a portable storage medium.

The analysis server 11 includes a control unit 111 and a storage unit 112. The control unit 111 includes an in-site location information acquisition unit 1111, an off-site location information acquisition unit 1112, an analysis unit 1113, and an output unit 1114. The storage unit 112 includes a location information storage unit 1121 and a user information storage unit 1122.

The storage unit 112 is a storage medium including a read only memory (ROM), a random access memory (RAM), a hard disk drive, and the like. The storage unit 112 previously stores a program which is executed by the control unit 111. The storage unit 112 may be provided outside the analysis server 11. In this case, the storage unit 112 may exchange data with the control unit 111 via the network.

The location information storage unit 1121 stores the location information of the communication terminal 13 inside and outside the site. The user information storage unit 1122 stores user information such as identification information, an attribute, and an address related to the user having the communication terminal 13 and stores association information for associating the identification information. The location information storage unit 1121 and the user information storage unit 1122 may be storage areas on the storage unit 112 or may be a database configured on the storage unit 112.

For example, the control unit 111 is a processor such as a central processing unit (CPU) and functions as the in-site location information acquisition unit 1111, the off-site location information acquisition unit 1112, the analysis unit 1113, and the output unit 1114 by executing a program stored in the storage unit 112. At least some of the functions of the control unit 111 may be performed by an electrical circuit. Also, at least some of the functions of the control unit 111 may be executed by a program which is executed via the network.

The shop server 12 includes a control unit 121 and a storage unit 122. The control unit 121 includes a location measurement unit 1211 and a location transmission unit 1212.

The storage unit 122 is a storage medium including a ROM, a RAM, a hard disk drive, and the like. The storage unit 122 previously stores the program which is executed by the control unit 121. The storage unit 122 may be provided outside the shop server 12. In this case, the storage unit 122 may exchange data with the control unit 121 via the network.

For example, the control unit 121 is a processor such as a CPU and functions as a location measurement unit 1211 and a location transmission unit 1212 by executing a program stored in the storage unit 122. At least some of the functions of the control unit 121 may be performed by an electrical circuit. Also, at least some of the functions of the control unit 121 may be executed by a program which is executed via the network.

The analysis system 1S according to the first embodiment is not limited to the specific configuration shown in FIG. 3. Each of the analysis server 11 and the shop server 12 is not limited to one device and may be configured by connecting two or more physically separated devices in a wired or wireless mode. Alternatively, the analysis server 11 and the shop server 12 may be integrated and configured as one device.

### [Description of Analysis Method]

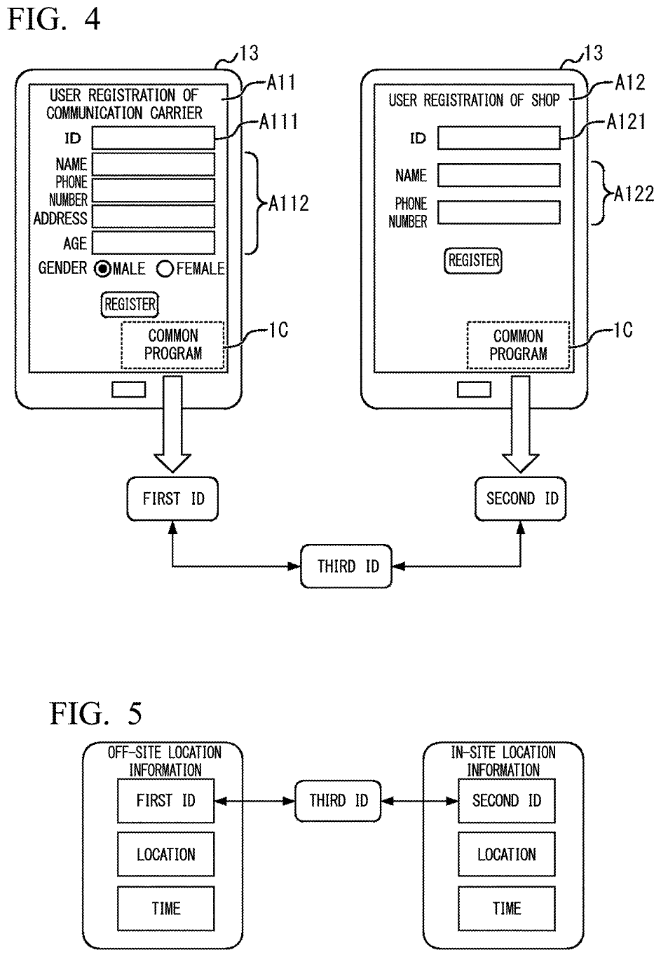

First, the user previously registers the user information in the analysis server 11 and the shop server 12 using the communication terminal 13. FIG. 4 is a front view of the communication terminal 13 displaying registration screens A11 and A12 for registering user information.

The registration screen A11 is a screen for inputting the user information which is registered in the analysis server 11. The communication terminal 13 executes an application (a program) for displaying the registration screen A11 in accordance with an operation of the user. The registration screen A11 includes a field A111 for inputting a first ID and a field A112 for inputting personal information such as a name, a phone number, an address, an age, and a gender. The first ID may be input by the user or may be automatically generated. The communication terminal 13 transmits content input to the registration screen A11 as the user information to the analysis server 11. The analysis server 11 causes the user information storage unit 1122 to store the user information received from the communication terminal 13. The analysis server 11 may use information previously registered by the user as the user information according to a communication network usage contract with the communication carrier. In this case, the analysis server 11 omits the registration screen A11, acquires the user information previously registered in a server of the communication carrier, and causes the user information storage unit 1122 to store the user information.

The registration screen A12 is a screen for inputting the user information which is registered in the shop server 12. The communication terminal 13 executes an application (a program) for displaying the registration screen A12 in accordance with an operation of the user. The registration screen A12 includes a field A121 for inputting a second ID and a field A122 for inputting personal information such as a name and a phone number. The second ID may be input by the user or may be automatically generated. The communication terminal 13 transmits content input to the registration screen A12 as the user information to the shop server 12. The shop server 12 causes the storage unit 122 to store the user information received from the communication terminal 13.

An application for displaying the registration screen A11 and an application for displaying the registration screen A12 include a common program 1C. The common program 1C is a program for transmitting the first ID or the second ID to the analysis server 11 and associating the first ID with the second ID. The common program 1C is provided as, for example, a software development kit (SDK) and is used in each application. When content input to the registration screen A11 or the registration screen A12 is transmitted, the communication terminal 13 transmits the first ID or the second ID to the analysis server 11 using the common program 1C. Also, the communication terminal 13 causes the storage unit of the communication terminal 13 to store the first ID and the second ID.

When the analysis server 11 has been received the first ID and the second ID from the same communication terminal 13, the analysis server 11 generates a third ID for identifying the user and causes the user information storage unit 1122 to store association information in which the first ID, the second ID, and the third ID are associated. The analysis server 11 transmits the third ID associated with the second ID to the shop server 12 and the shop server 12 causes the storage unit 122 to store the second ID and the third ID in association.

The analysis server 11 may directly associate the first ID with the second ID without using the third ID and cause the user information storage unit 1122 to store an association result. The analysis server 11 may associate the first ID with the second ID using the first ID and the second ID from the same communication terminal 13 and cause the user information storage unit 1122 to store an association result. As described above, the analysis server 11 and the shop server 12 can associate the first ID with the second ID without exchanging personal information with each other.

The communication terminal 13 may automatically generate at least one of the first ID and the second ID without using the registration screens A11 and A12. In this case, the communication terminal 13 uses an ID (for example, an advertisement ID) automatically generated regardless of the operation of the user as the first ID or the second ID.

After the user information of the user is registered in the analysis server 11 and the shop server 12, the analysis server 11 and the shop server 12 start the measurement of the location of the communication terminal 13 of the user. When the communication terminal 13 is present inside the site 1P, the communication terminal 13 is connected to one of the plurality of beacons 15 through short-range wireless communication and transmits the second ID stored in the storage unit of the communication terminal 13 to the shop server 12 via the beacon 15. The communication terminal 13 may transmit the second ID to the analysis server 11 via the base station 14 without involving the beacon 15. In this case, the communication terminal 13 transmits the second ID to the analysis server 11 via the base station 14 at a timing that is the same as a timing when the beacon 15 measures the location of the communication terminal 13. Thereby, the analysis server 11 can associate the location of the communication terminal 13 measured using the beacon 15 with the second ID of the communication terminal 13 received via the base station 14.

The location measurement unit 1211 of the shop server 12 periodically measures the location of the communication terminal 13 on the basis of the location of the beacon 15 to which the communication terminal 13 is connected. The location measurement unit 1211 may determine the location of one beacon 15 to which the communication terminal 13 is connected as the location of the communication terminal 13 or may calculate the location of the communication terminal 13 through triangulation based on locations of a plurality of beacons 15 to which the communication terminal 13 is connected. The location transmission unit 1212 transmits a measured location and a measurement time to the analysis server 11 in association with the second ID of the communication terminal 13. The in-site location information acquisition unit 1111 of the analysis server 11 receives the location inside the site 1P and the measurement time transmitted by the shop server 12 together with the second ID. The location transmission unit 1212 may transmit a third ID associated with the second ID instead of the second ID.

When the communication terminal 13 is present outside the site 1P, the communication terminal 13 periodically receives a GPS signal and measures the location of the communication terminal 13 on the basis of the received GPS signal. As another method, the communication terminal 13 may measure the location of the communication terminal 13 on the basis of a location of the base station 14 (a cell) capable of communicating with the communication terminal 13. In this case, the communication terminal 13 acquires locations of a plurality of base stations 14 capable of communicating with the communication terminal 13 and calculates the location of the communication terminal 13 through triangulation based on the acquired locations of the plurality of base stations 14.

The communication terminal 13 transmits a measured location and a measurement time to the analysis server 11 via the base station 14 in association with the first ID stored in the storage unit of the communication terminal 13. The off-site location information acquisition unit 1112 of the analysis server 11 receives the location outside the site 1P and the measurement time transmitted by the communication terminal 13 together with the first ID. The communication terminal 13 may transmit a third ID associated with the first ID instead of the first ID.

FIG. 5 is a schematic diagram of the off-site location information and the in-site location information acquired by the analysis server 11.

The in-site location information acquisition unit 1111 (a first acquisition unit) acquires the second ID, the location, and the measurement time received from the shop server 12 as in-site location information (first location information) and causes the location information storage unit 1121 to store the in-site location information. The in-site location information acquisition unit 1111 acquires a route (i.e., a flow line) along which the communication terminal 13 has moved inside the site 1P by acquiring the in-site location information indicating a plurality of locations at a plurality of different measurement times.

The off-site location information acquisition unit 1112 (a second acquisition unit) acquires the first ID, the location, and the measurement time received from the communication terminal 13 as off-site location information (second location information), and causes the location information storage unit 1121 to store the off-site location information. The off-site location information acquisition unit 1112 may acquire a route (i.e., a flow line) along which the communication terminal 13 has moved outside the site 1P by acquiring the off-site location information indicating a plurality of locations at a plurality of different measurement times. The first ID of the off-site location information and the second ID of the in-site location information can be associated via the third ID. The third ID may be omitted and the first ID and the second ID may be directly associated. Alternatively, the first ID and the second ID may be the same.

The analysis unit 1113 acquires the off-site location information and the in-site location information stored in the location information storage unit 1121. The analysis unit 1113 associates the off-site location information and the in-site location information by associating the first ID of the off-site location information with the second ID of the in-site location information on the basis of the association information stored in the user information storage unit 1122.

Specifically, the analysis unit 1113 acquires a set of the first ID and the second ID associated with the association information stored in the user information storage unit 1122. The analysis unit 1113 associates the off-site location information including the acquired first ID with the in-site location information including the acquired second ID.

The analysis unit 1113 analyzes the off-site location information and the in-site location information that have been associated. First, the analysis unit 1113 identifies the site 1P visited by the user having the communication terminal 13 outside the site 1P on the basis of the off-site location information.

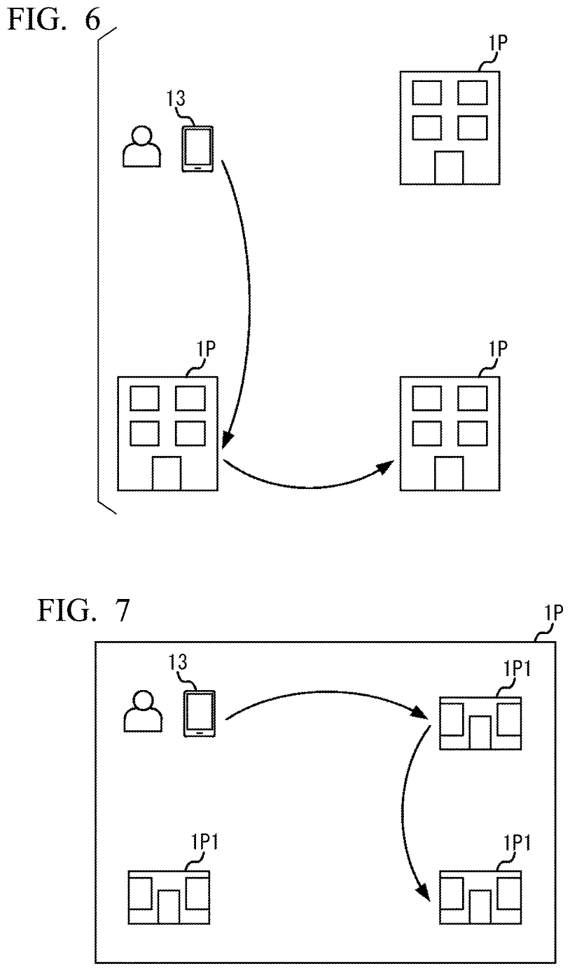

FIG. 6 is a schematic diagram of the flow line of the communication terminal 13 outside the site 1P indicated by the off-site location information.

The analysis unit 1113 identifies the site 1P (for example, a facility such as a shopping center) near the location of the communication terminal 13 indicated by the off-site location information as the site 1P visited by the user. At this time, the analysis unit 1113 may identify a certain site 1P as the site 1P visited by the user when a time period of his or her stay in the certain site 1P is greater than or equal to a prescribed value.

Next, the analysis unit 1113 identifies a shop visited by the user having the communication terminal 13 inside the site 1P on the basis of the in-site location information. FIG. 7 is a schematic diagram of the flow line of the communication terminal 13 in the site 1P indicated by the in-site location information. The analysis unit 1113 identifies a shop 1P1 near the location of the communication terminal 13 indicated by the in-site location information as the shop 1P1 visited by the user. At this time, the analysis unit 1113 may identify a certain shop 1P1 as the shop 1P1 visited by the user when a time period of his or her stay in the certain shop 1P1 is greater than or equal to a prescribed value.

Also, the analysis unit 1113 may identify an area visited by the user inside the shop 1P1 (for example, a product shelf or a sales floor inside the shop 1P1) on the basis of the in-site location information. In this case, the analysis unit 1113 identifies an area inside the shop 1P1 near the location of the communication terminal 13 indicated by the in-site location information as the area visited by the user. At this time, the analysis unit 1113 may identify an area inside a certain shop 1P1 as the area visited by the user when a time period of his or her stay in the area is greater than or equal to a prescribed value.

The storage unit 112 previously stores shop information indicating products or services being handled in each shop and products or services being handled in each area inside the shop. The analysis unit 1113 uses the shop information stored in the storage unit 112 to extract a product or a service being handled in a site 1P, a shop, and an area visited by the user identified on the basis of the in-site location information and the off-site location information.

The analysis unit 1113 estimates the extracted product or service as a product or a service in which the user is interested. At this time, the analysis unit 1113 may estimate a product or a service extracted a prescribed number of times or more on the basis of the in-site location information and the off-site location information (i.e., being handled in a plurality of sites 1P, shops, and areas visited by the user) as the product or the service in which the user is interested. Thereby, the analysis unit 1113 can estimate that a product or a service that the user has approached many times is the product or the service in which the user is interested. The analysis unit 1113 delivers information about the product or the service estimated to be of interest to the user as an analysis result to the output unit 1114. Also, the analysis unit 1113 may determine benefits such as discount coupons for the product or the service estimated to be of interest to the user and deliver the benefits as the analysis result to the output unit 1114. For example, the benefits are displayed as a code on the communication terminal 13 and are used when the code is read by the shop terminal.

Further, the analysis unit 1113 may use the shop information stored in the storage unit 112 to identify a shop or an area in the shop handling a product or a service estimated to be of interest to the user. In this case, the analysis unit 1113 may identify a shop in the vicinity of an address of the user stored in the user information storage unit 1122 (for example, within a prescribed distance).

As described above, the analysis unit 1113 can associate the location information inside and outside the site 1P and consistently analyze the site 1P, the shop 1P1, and the area inside the shop 1P1 visited by the user. Thus, the business operator can comprehensively know a trend and interest indicated by the behavior of the user by connecting the flow lines inside and outside the site 1P.

The analysis performed by the analysis unit 1113 shown here is an example and the analysis unit 1113 may perform other analysis on the basis of the off-site location information and the in-site location information associated using the first ID and the second ID.

The analysis unit 1113 may statistically analyze in-site location information and off-site location information of a plurality of users. In this case, the analysis unit 1113 acquires attributes such as ages, places of residence, and genders of the users from the user information storage unit 1122. The analysis unit statistically analyzes the in-site location information and the off-site location information of the plurality of users according to each of the attributes of the ages, the places of residence, and the genders of the users. Thereby, the analysis unit 1113 can rank products or services in which the users are interested for each attribute and can acquire the trend of the flow line for each of the attributes of the users.

The analysis unit 1113 may identify information about a location where the user has stayed for a prescribed time or longer (for example, an estimated place of residence of the user) on the basis of the off-site location information. The analysis unit 1113 identifies an area with a large number of users or an area with a small number of users by statistically analyzing locations where a plurality of users have stayed. Thereby, the analysis unit 1113 can provide an area where the number of users is large or small as the analysis result. The shop business operator can perform a determination of whether or not to advertise in each area on the basis of the analysis result of the area where the number of users is large or small and the like.

The output unit 1114 outputs the analysis results of the analysis unit 1113. The output unit 1114 may output the analysis results by causing the storage unit 112 to store the analysis results or may output the analysis results by transmitting the analysis results to the shop server 12. Alternatively, the output unit 1114 may output the analysis results by causing the display unit of the communication terminal 13 to display the analysis results. In this case, the output unit 1114 transmits the analysis results of the analysis unit 1113 to the communication terminal 13. The output unit 1114 may transmit the analysis results to the communication terminal 13 while the user is present inside the shop or may transmit the analysis results to the communication terminal 13 when the user has left the shop.

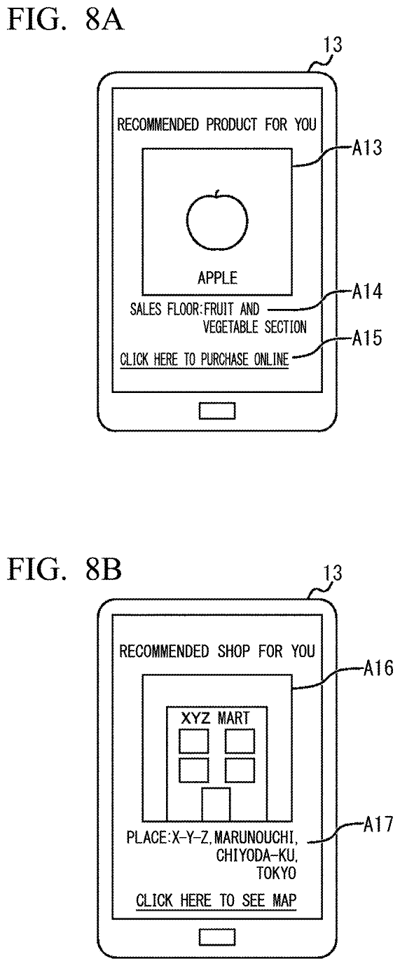

FIGS. 8A and 8B are front views of the communication terminal 13 displaying the analysis results of the analysis unit 1113. In FIG. 8A, the communication terminal 13 displays a product A13 (or a service) estimated to be of interest to the user by the analysis unit 1113. Further, the communication terminal 13 displays information A14 indicating an area (a product shelf or a sales floor) inside the shop handling the product A13. Further, the communication terminal 13 displays a link A15 indicating a website (an EC site or the like) handling the product A13. Further, the communication terminal 13 may display benefits such as discount coupons determined by the analysis unit 1113 together with the product A13. Thereby, the user can know which product or service is estimated to be of interest and where the product or the service can be purchased. The business operator can actively guide the user to a product or a service estimated to be of interest and promote sales.

In FIG. 8B, the communication terminal 13 displays a shop A16 handling a product or a service estimated to be of interest to the user by the analysis unit 1113. Further, the communication terminal 13 displays information A17 indicating a location of the shop A16. Thereby, the user can know a shop handling the product or the service estimated to be of interest and a place thereof. Thereby, the user can know a shop where the product or the service estimated to be of interest can be purchased and a place thereof. The business operator can actively guide the user to a shop where he/she can purchase a product or a service estimated to be of interest and promote sales.

Although the analysis server 11 transmits the analysis results to the communication terminal 13 in the first embodiment, the shop server 12 may transmit the analysis results acquired from the analysis server 11 to the communication terminal 13.

### [Sequence of Analysis Method]

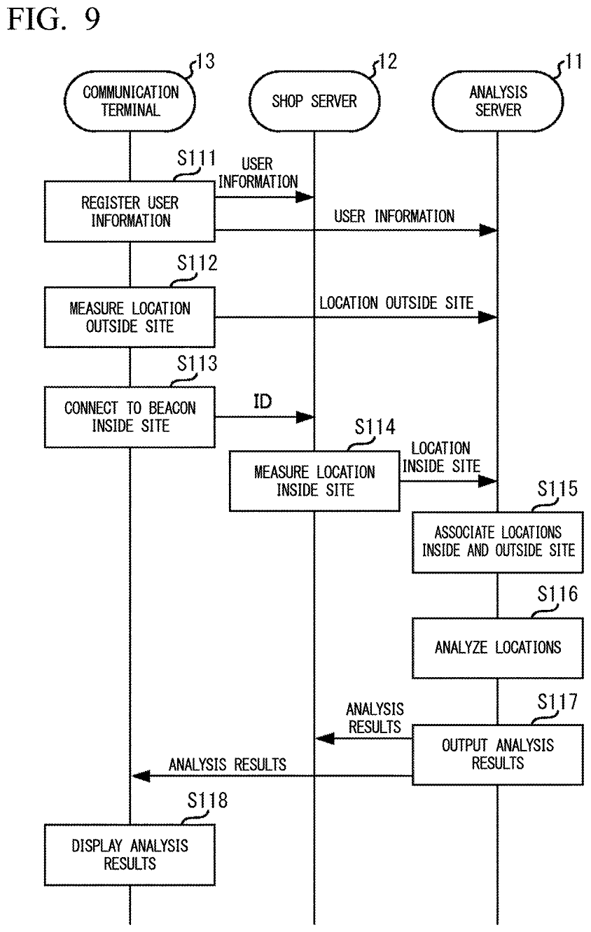

FIG. 9 is a sequence diagram of an analysis method executed by the analysis system 1S according to the first embodiment. First, the user previously registers user information in the analysis server 11 and the shop server 12 using the communication terminal 13 (S111). The analysis server 11 causes the user information storage unit 1122 to store the user information received from the communication terminal 13. The shop server 12 causes the storage unit 122 to store the user information received from the communication terminal 13.

When the communication terminal 13 is present outside the site, the communication terminal 13 periodically receives a GPS signal and measures a location of the communication terminal 13 on the basis of the received GPS signal (S112). The communication terminal 13 transmits the measured location and a measurement time to the analysis server 11 via the base station 14 in association with a first ID stored in the storage unit of the communication terminal 13. The off-site location information acquisition unit 1112 of the analysis server 11 acquires the first ID, the location, and the measurement time received from the communication terminal 13 as off-site location information and causes the location information storage unit 1121 to store the off-site location information.

When the communication terminal 13 is present inside the site, the communication terminal 13 is connected to one of the plurality of beacons 15 through short-range wireless communication and transmits a second ID stored in the storage unit of the communication terminal 13 to the shop server 12 via the beacon 15 (S113). The location measurement unit 1211 of the shop server 12 periodically measures a location of the communication terminal 13 on the basis of a location of the beacon 15 to which the communication terminal 13 is connected (S114). The location transmission unit 1212 of the shop server 12 transmits the measured location and a measurement time to the analysis server 11 in association with the second ID of the communication terminal 13. The in-site location information acquisition unit 1111 of the analysis server 11 acquires the second ID, the location, and the measurement time received from the shop server 12 as in-site location information and causes the location information storage unit 1121 to store the in-site location information.

Step S112 of measuring a location outside the site and steps S113 to S114 of measuring a location inside the site are iteratively performed. The analysis server 11 performs an analysis process from step S115 at a prescribed timing. For example, the analysis server 11 may sequentially analyze newly stored in-site location information or off-site location information or may collectively analyze in-site location information and off-site location information stored within a prescribed period.

The analysis unit 1113 acquires the off-site location information and the in-site location information stored in the location information storage unit 1121. The analysis unit 1113 associates the in-site location information with the off-site location information by associating the first ID of the off-site location information with the second ID of the in-site location information on the basis of the association information stored in the user information storage unit 1122 (S115).

The analysis unit 1113 analyzes the off-site location information and the in-site location information that have been associated (S116). For example, the analysis unit 1113 identifies a site 1P, a shop, and an area visited by the user on the basis of the off-site location information and the in-site location information that have been associated and further estimates a product or a service in which the user is interested.

The output unit 1114 outputs analysis results of the analysis unit 1113 (S117). For example, the output unit 1114 causes the storage unit 112 to store the analysis results, transmits the analysis results to the shop server 12, and transmits the analysis results to the communication terminal 13. The communication terminal 13 displays the analysis results of the analysis unit 1113 received from the analysis server 11 on the display unit (S118).

### [Effects of First Embodiment]

The analysis system 1S according to the first embodiment associates the off-site location information with the in-site location information by associating the first ID for identifying the communication terminal 13 or the user outside the site 1P with the second ID for identifying the communication terminal 13 or the user inside the site 1P and analyzes the off-site location information and the in-site location information that have been associated. Thus, the analysis system 1S can consistently analyze locations of the communication terminal 13 measured in mutually different measurement methods inside and outside the site 1P such as a shop.

### Modified Examples

The analysis unit 1113 may associate the user information registered in the analysis server 11 with the in-site location information measured by the shop server 12 by associating the first ID with the second ID.

As shown in FIG. 4, the amount of personal information registered in a registration screen A11 of the analysis server 11 may be larger than the amount of personal information registered in a registration screen A12 of the shop server 12. In this case, the analysis unit 1113 can analyze the in-site location information using more personal information by associating the user information registered in the analysis server 11 with the in-site location information measured by the shop server 12 on the basis of the first ID and the second ID.

In contrast, the analysis unit 1113 may associate the off-site location information acquired by the analysis server 11 with the user information registered in the shop server 12 by associating the first ID with the second ID.

Although the present invention has been described above using the embodiments, the technical scope of the present invention is not limited to the scope described in the above-described embodiments and various modifications and changes are possible within the scope of the subject matter thereof. For example, the specific embodiment of the distribution/integration of the devices is not limited to the above-described embodiment and all or a part thereof can be configured to be functionally or physically distributed/integrated in any unit. Also, a new embodiment produced by any combination of a plurality of embodiments is also included in the embodiment of the present invention. The effect of the new embodiment produced by the combination has the effect of the above-described embodiment.

Processors of the analysis server 11, the shop server 12, and the communication terminal 13 serve as main components for performing steps included in the analysis method shown in FIG. 9. That is, the processors of the analysis server 11, the shop server 12, and the communication terminal 13 execute the analysis method shown in FIG. 9 by reading a program for executing the analysis method shown in FIG. 9 from the storage unit and executing the program to control each part of the analysis system 1S. Some of the steps included in the analysis method shown in FIG. 9 may be omitted, the order between the steps may be changed, and a plurality of steps may be performed in parallel.

### [Overview of Analysis System 2S]

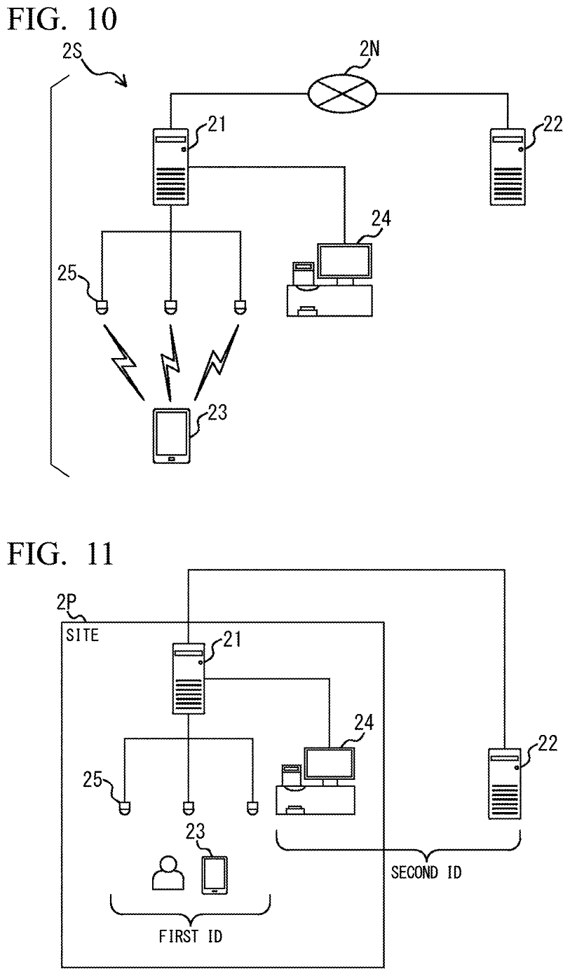

FIG. 10 is a schematic diagram of an analysis system 2S according to a second embodiment. The analysis system 2S includes a shop server 21, a payment server 22, and a user terminal 23. The analysis system 2S may include equipment such as other servers and terminals.

The shop server 21 (an information processing device) is a computer that acquires and analyzes location information of the user terminal 23 and payment information indicating content of payment performed by the user using the user terminal 23. The shop server 21 acquires the location information of the user terminal 23 inside a site using a beacon 25 installed inside the site such as a shop.

Also, the shop server 21 uses a shop terminal 24 such as a point of sale (POS) terminal installed inside the site to acquire information about a product or a service which is purchased by the user and perform a payment process in collaboration with the payment server 22. The shop terminal 24 has a display unit such as a liquid crystal display for displaying various information. The shop server 21 exchanges information about payment with the payment server 22 via a network 2N such as the Internet or a local area network (LAN). Although the shop terminal 24 exchanges information about payment with the payment server 22 via the shop server 21 in the example of FIG. 10, the shop terminal 24 may directly exchange information about payment with the payment server 22 without involving the shop server 21,

The payment server 22 (a payment device) is a computer that executes payment. The payment server 22 executes online payment of a fee of a product or a service which is purchased by the user via the network 2N.

The user terminal 23 (a communication terminal) is a computer capable of performing communication. For example, the user terminal 23 is a smartphone, a portable terminal such as a tablet terminal, or a personal computer. The user terminal 23 includes a communication unit for performing wireless communication of Long Term Evolution (LTE), Bluetooth, a wireless LAN, or the like. Also, the user terminal 23 includes a display unit such as a liquid crystal display for displaying various information.

FIG. 11 is a schematic diagram of an analysis method executed by the analysis system 2S according to the second embodiment. A user having the user terminal 23 moves inside the site 2P such as a shop. The site 2P may be a site (a building or land) of one shop or may be a site of a complex of a plurality of shops such as a shopping center or a department store.

A plurality of beacons 25 are installed at different locations inside the site 2P. The beacon 25 is a location measurement device that can be connected to the user terminal 23 through short-range wireless communication of Bluetooth, a wireless LAN, or the like. For example, the user terminal 23 is connected to the beacon 25 through short-range wireless communication when the user enters the site 2P. The shop server 21 measures the location of the user terminal 23 inside the site on the basis of the location of the beacon 25 to which the user terminal 23 is connected. The shop server 21 records the location of the user terminal 23 inside the site 2P in association with a first ID (first identification information) serving as the identification information for identifying the user terminal 23 or the user. For example, the first ID is assigned and managed by a shop business operator who operates a shop inside the site 2P.

The user uses the user terminal 23 to perform payment of a fee of a product or a service of a purchase target in the shop terminal 24. When the payment is performed, the user terminal 23 provides a second ID (second identification information) serving as identification information for identifying the user terminal 23 or the user to the payment server 22. The payment server 22 executes the payment of the fee of the product or the service of a purchase target acquired by the shop server 21 using the shop terminal 24 on the basis of the second ID and transmits a payment result to the shop server 21 together with the second ID. The shop server 21 records payment information indicating the product or the service of the purchase target and the second ID received from the payment server 22. For example, the second ID is assigned and managed by a communication carrier that operates an online payment service.

The shop server 21 associates the location information of the user terminal 23 with the payment information of the payment using the user terminal 23 by associating the first ID with the second ID. The shop server 21 analyzes the location information and the payment information associated with each other and outputs analysis results.

As described above, the analysis system 2S associates the first ID used for acquiring the location information of the user terminal 23 with the second ID used for the payment using the user terminal 23. Thus, the analysis system 2S can automatically associate the location information and the payment information of the user in the shop and can reduce the time and effort required to associate the location information with the payment information and analyze the location information and the payment information that have been associated.

### [Configuration of Analysis System 2S]

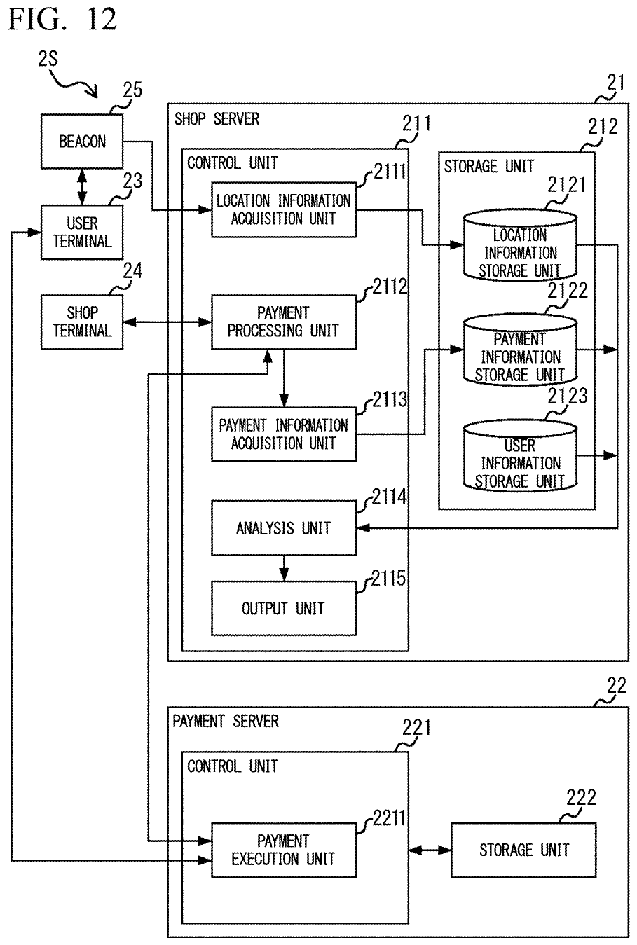

FIG. 12 is a block diagram of the analysis system 2S according to the second embodiment. In FIG. 12, arrows indicate main data flows. There may be data flows other than those shown in FIG. 12. In FIG. 12, each block shows a functional unit configuration instead of a hardware (device) unit configuration. Thus, the blocks shown in FIG. 12 may be implemented within a single device or may be implemented separately within a plurality of devices. Data may be transmitted and received between blocks via any means such as a data bus, a network, or a portable storage medium.

The shop server 21 includes a control unit 211 and a storage unit 212. The control unit 211 includes a location information acquisition unit 2111, a payment processing unit 2112, a payment information acquisition unit 2113, an analysis unit 2114, and an output unit 2115. The storage unit 212 includes a location information storage unit 2121, a payment information storage unit 2122, and a user information storage unit 2123.

The storage unit 212 is a storage medium including a read only memory (ROM), a random access memory (RAM), a hard disk drive, and the like. The storage unit 212 previously stores a program which is executed by the control unit 211. The storage unit 212 may be provided outside the shop server 21. In this case, the storage unit 212 may exchange the data with the control unit 211 via the network.

The location information storage unit 2121 stores location information of the user terminal 23. The payment information storage unit 2122 stores payment information indicating content of the payment performed using the user terminal 23. The user information storage unit 2123 stores user information such as identification information, an attribute, and an address related to the user having the user terminal 23, and stores association information for associating the identification information. Each of the location information storage unit 2121, the payment information storage unit 2122, and the user information storage unit 2123 may be a storage area on the storage unit 212, or may be a database configured on the storage unit 212.

For example, the control unit 211 is a processor such as a central processing unit (CPU) and functions as the location information acquisition unit 2111, the payment processing unit 2112, the payment information acquisition unit 2113, the analysis unit 2114, and the output unit 2115 by executing the program stored in the storage unit 212. At least some of the functions of the control unit 211 may be performed by an electrical circuit. Also, at least some of the functions of the control unit 211 may be executed by the program executed via the network.

The payment server 22 includes a control unit 221 and a storage unit 222. The control unit 221 includes a payment execution unit 2211. The storage unit 222 is a storage medium including a ROM, a RAM, a hard disk drive, and the like. The storage unit 222 previously stores a program which is executed by the control unit 221. The storage unit 222 may be provided outside the payment server 22. In this case, the storage unit 222 may exchange the data with the control unit 221 via the network.

For example, the control unit 221 is a processor such as a CPU and functions as a payment execution unit 2211 by executing a program stored in the storage unit 222. At least some of the functions of the control unit 221 may be performed by an electrical circuit. Also, at least some of the functions of the control unit 221 may be executed by a program executed via the network.

The analysis system 2S according to the second embodiment is not limited to the specific configuration shown in FIG. 12. Each of the shop server 21 and the payment server 22 is not limited to one device and may be configured by connecting two or more physically separated devices in a wired or wireless mode. Alternatively, the shop server 21 and the payment server 22 may be integrated and configured as one device.

### [Description of Analysis Method]

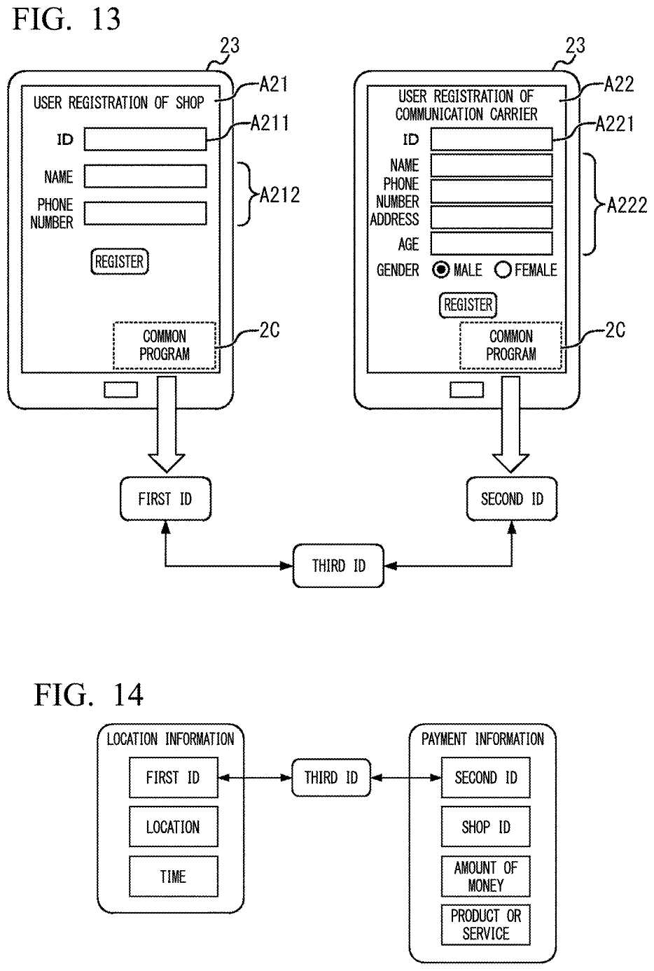

First, the user previously registers the user information in the shop server 21 and the payment server 22 using the user terminal 23. FIG. 13 is a front view of the user terminal 23 displaying registration screens A21 and A22 for registering user information.

The registration screen A21 is a screen for inputting the user information to be registered in the shop server 21. The user terminal 23 executes an application (a program) for displaying the registration screen A21 in accordance with an operation of the user. The registration screen A21 includes a field A211 for inputting the first ID and a field A212 for inputting personal information such as a name and a phone number. The first ID may be input by the user or may be automatically generated. The user terminal 23 transmits content input to the registration screen A21 as user information to the shop server 21. The shop server 21 causes the user information storage unit 2123 to store the user information received from the user terminal 23.

The registration screen A22 is a screen for inputting the user information to be registered in the payment server 22. The user terminal 23 executes an application (a program) for displaying the registration screen A22 in accordance with an operation of the user. The registration screen A22 includes a field A221 for inputting a second ID and a field A222 for inputting personal information such as a name, a phone number, an address, an age, and a gender.

The second ID may be input by the user or may be automatically generated. The user terminal 23 transmits content input to the registration screen A22 as the user information to the payment server 22. The payment server 22 causes the storage unit 222 to store the user information received from the user terminal 23.

An application for displaying the registration screen A21 and an application for displaying the registration screen A22 include a common program 2C. The common program 2C is a program for transmitting the first ID or the second ID to the shop server 21 and associating the first ID with the second ID. For example, the common program 2C is provided as a software development kit (SDK) and is used in each application. When content input to the registration screen A21 or the registration screen A22 is transmitted, the user terminal 23 transmits the first ID or the second ID to the shop server 21 using the common program 2C. Also, the user terminal 23 causes the storage unit of the user terminal 23 to store the first ID and the second ID.

When the first ID and the second ID have been received from the same user terminal 23, the shop server 21 generates a third ID for identifying the user, and causes the user information storage unit 2123 to store association information in which the first ID, the second ID, and the third ID are associated. The shop server 21 transmits the third ID associated with the second ID to the payment server 22 and the payment server 22 causes the storage unit 222 to store the second ID and the third ID in association.

The shop server 21 may directly associate the first ID with the second ID without using the third ID and cause the user information storage unit 2123 to store an association result. The shop server 21 may associate the first ID with the second ID using the first ID and the second ID from the same user terminal 23 and cause the user information storage unit 2123 to store an association result. As described above, the shop server 21 and the payment server 22 can associate the first ID with the second ID without exchanging personal information with each other.

The user terminal 23 may automatically generate at least one of the first ID and the second ID without using the registration screens A21 and A22. In this case, the user terminal 23 uses the automatically generated ID (for example, an advertisement ID) as the first ID or the second ID regardless of the operation of the user.

After the user information is registered in the shop server 21, the shop server 21 starts the measurement of the location of the user terminal 23. When the user terminal 23 is present inside the site 2P, the user terminal 23 is connected to one of the plurality of beacons 25 through short-range wireless communication and the first ID stored in the storage unit of the user terminal 23 is transmitted to the shop server 21 via the beacon 25.

The location information acquisition unit 2111 of the shop server 21 periodically measures the location of the user terminal 23 on the basis of the location of the beacon 25 to which the user terminal 23 is connected. The location information acquisition unit 2111 may determine the location of one beacon 25 to which the user terminal 23 is connected as the location of the user terminal 23 or may calculate the location of the user terminal 23 through triangulation based on locations of a plurality of beacons 25 to which the user terminal 23 is connected.

The location information acquisition unit 2111 causes the location information storage unit 2121 to store the first ID of the user terminal 23, the measured location, and a measurement time as location information. The location information acquisition unit 2111 may acquire a plurality of locations at a plurality of different times and cause the location information storage unit 2121 to store the location information indicating a route (i.e., a flow line) along which the user terminal 23 has moved inside the site 2P. The location information acquisition unit 2111 may cause the location information storage unit 2121 to store the location information indicating the third ID associated with the first ID in instead of the first ID.

The user presents a product or a service of a purchase target to the shop terminal 24 so that payment is performed.

The payment processing unit 2112 of the shop server 21 acquires information indicating the product or the service of the purchase target of the user using the shop terminal 24 and transmits the information to the payment server 22. When the payment is performed, the user terminal 23 transmits the second ID stored in the storage unit of the user terminal 23 to the shop server 21 or the payment server 22. When the second ID has been received from the user terminal 23, the payment processing unit 2112 of the shop server 21 transmits the second ID to the payment server 22.

The payment execution unit 2211 of the payment server 22 receives the information indicating the product or the service of the purchase target from the shop server 21 and receives the second ID of the user terminal 23 performing the payment from the shop server 21 or the user terminal 23. The payment execution unit 2211 executes the payment of a fee of the product or the service of the purchase target on the basis of the second ID. For example, the payment server 22 previously stores a payment method of a credit card, a bank account, or the like in association with the second ID and the payment execution unit 2211 executes the payment of the fee of the product or the service of the purchase target using the payment method associated with the second ID. The payment execution unit 2211 transmits a payment result (for example, the amount of money of the payment) and the second ID to the shop server 21.

The payment information acquisition unit 2113 of the shop server 21 causes the payment information storage unit 2122 to store the second ID and the amount of money of the payment received from the payment server 22, a shop ID which is the identification information for identifying the shop, and a name of the product or the service of the purchase target as payment information. The payment information acquisition unit 2113 may cause the payment information storage unit 2122 to store the payment information indicating the third ID associated with the second ID instead of the second ID.

Here, although an example in which the second ID is associated with the payment information by performing online payment using the second ID has been described, the user may present a point card or the like indicating the second ID to the shop terminal 24 when payment is performed using cash. Thereby, the shop server 21 can associate the second ID with the payment information.

FIG. 14 is a schematic diagram of location information and payment information acquired by the shop server 21. The location information acquisition unit 2111 (a first acquisition unit) acquires the first ID received from the user terminal 23, a measured location, and a measurement time as location information and causes the location information storage unit 2121 to store the location information.

The payment information acquisition unit 2113 (a second acquisition unit) acquires the second ID and the amount of money of the payment received from the payment server 22, the shop ID, and the name of the product or the service of the purchase target as payment information and causes the payment information storage unit 2122 to store the payment information.

The first ID of the location information and the second ID of the payment information can be associated via the third ID. The third ID may be omitted and the first ID and the second ID may be directly associated. Alternatively, the first ID and the second ID may be the same.

The analysis unit 2114 acquires the location information stored in the location information storage unit 2121. Also, the analysis unit 2114 acquires the payment information stored in the payment information storage unit 2122. The analysis unit 2114 associates the location information with the payment information by associating the first ID of the location information with the second ID of the payment information on the basis of the association information stored in the user information storage unit 2123. When the site 2P includes a plurality of shops, the analysis unit 2114 may associate the location information with the payment information in a plurality of shops.

Specifically, the analysis unit 2114 acquires the second ID associated with the payment information and acquires the first ID associated with the acquired second ID from the user information storage unit 2123. The analysis unit 2114 associates the location information associated with the acquired first ID with the payment information associated with the acquired second ID.

The analysis unit 2114 analyzes the location information and the payment information that have been associated. First, the analysis unit 2114 identifies an area (for example, a product shelf or a sales floor inside a shop) visited by a user having a user terminal 23 inside the site 2P on the basis of the location information. When the site 2P is a complex of a plurality of shops, the analysis unit 2114 may identify the shop visited by the user among the plurality of shops.

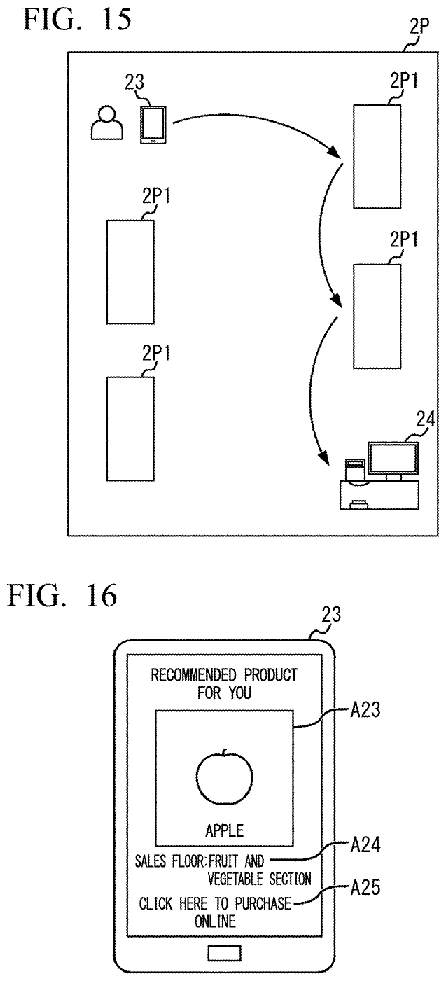

FIG. 15 is a schematic diagram of the flow line of the user terminal 23 in the site 2P indicated by the location information. The analysis unit 2114 identifies an area 2P1 inside the site 2P near the location of the user terminal 23 indicated by the location information as the area 2P1 visited by the user. At this time, the analysis unit 2114 may identify a certain area 2P1 as the area 2P1 visited by the user when a time period of his or her stay in the vicinity of the certain area 2P1 is greater than or equal to a prescribed value. Further, the analysis unit 2114 may identify a time when the location of the user terminal 23 indicated by the location information has approached the location of the shop terminal 24 as a time when the user has performed payment.

The storage unit 212 previously stores shop information indicating a product or a service being handled in each area 2P1 inside the shop. The analysis unit 2114 uses the shop information stored in the storage unit 212 to extract the product or the service being handled in the area 2P1 visited by the user identified on the basis of the location information.

Next, the analysis unit 2114 classifies products or services being handled in the area 2P1 visited by the user into a product or a service purchased by the user and a product or a service not purchased by the user on the basis of the payment information to perform analysis. For example, the analysis unit 2114 estimates a product or a service being handled in the area 2P1 visited by the user but not purchased by the user as a product or a service in which the user is interested. At this time, the analysis unit 2114 may estimate a product or a service extracted a prescribed number of times or more on the basis of the location information (i.e., being handled in the plurality of areas 2P1 visited by the user) as the product or the service in which the user is interested. Thereby, the analysis unit 2114 can estimate that the product or the service that the user has approached many times is the product or the service in which the user is interested. The analysis unit 2114 delivers the information about the product or the service estimated to be of interest to the user to the output unit 2115 as the analysis result.

Also, the analysis unit 2114 identifies the product or the service purchased by the user on the basis of the payment information and extracts a related product (or a related service) related to a product (or a service) purchased by the user. The analysis unit 2114 identifies a shop, which has not been visited by the user and is handling a related product, among a plurality of shops included in the site 2P on the basis of the location information. The analysis unit 2114 delivers information about the related product and the shop to the output unit 2115 as the analysis result. Further, the analysis unit 2114 may determine benefits such as discount coupons available for payment to be performed by the user using the user terminal 23 with respect to the extracted related product and deliver the benefits as an analysis result to the output unit 2115. For example, the benefits are displayed as a code on the user terminal 23 and are used when the code is read by the shop terminal 24.

Also, the analysis unit 2114 delivers information about a shop serving food and drink (a restaurant, a café, or the like) inside the site 2P as the analysis result to the output unit 2115 when the payment information does not indicate payment at the shop serving food and drink inside the site 2P and the location information does not indicate the visit to the shop serving food and drink. Further, the analysis unit 2114 may determine benefits such as discount coupons available for payment to be performed by the user using the user terminal 23 with respect to the shop serving food and drink inside the site 2P and deliver the benefits as an analysis result to the output unit 2115. In this case, the output unit 2115 may output information about the shop serving food and drink to the user terminal 23 only in a specific time period (for example, around 12:00) or when the user has stayed inside the site 2P for a prescribed time or longer.

As described above, the analysis unit 2114 can easily associate the location information with the payment information and analyze the location information and the payment information that have been associated. Thus, the business operator can analyze a relationship between a flow line of the user and purchase content of the user and comprehensively know the trend and interest of the behavior of the user.

The analysis performed by the analysis unit 2114 shown here is an example and the analysis unit 2114 may perform other analysis on the basis of the location information and the payment information that have been associated using the first ID and the second ID.

The analysis unit 2114 may statistically analyze location information and payment information of a plurality of users. In this case, the analysis unit 2114 acquires attributes such as an age, a place of residence, and a gender of the user from the user information storage unit 2123. The analysis unit 2114 statistically analyzes the location information and the payment information associated with the plurality of users for each of attributes such as ages, places of residence, and genders of the users. Thereby, the analysis unit 2114 can rank products or services in which the users are interested for each attribute and can acquire the trend of the flow line and purchase content for each of the attributes of the users.

The output unit 2115 outputs the information generated by associating the location information with the payment information in the analysis unit 2114. The information generated by associating the location information with the payment information may be the location information and the payment information themselves associated with each other or may be analysis results of the location information and the payment information associated with each other. The output unit 2115 may output the location information, the payment information, and the analysis results by causing the storage unit 212 to store them. Alternatively, the output unit 2115 may output the analysis results by causing the display unit of the user terminal 23 to display the analysis results. In this case, the output unit 2115 transmits the analysis results of the analysis unit 2114 to the user terminal 23. The output unit 2115 may transmit the analysis results to the user terminal 23 while the user is present inside the shop or may transmit the analysis results to the user terminal 23 when the user has left the shop.

FIG. 16 is a front view of the user terminal 23 displaying the analysis results of the analysis unit 2114. The user terminal 23 displays a product A23 (or a service) estimated to be of interest to the user by the analysis unit 2114. Further, the user terminal 23 displays information A24 indicating an area (a product shelf or a sales floor) inside the shop handling the product A23. Further, the user terminal 23 displays a link A25 indicating a website (an EC site or the like) that handles the product A23. This allows the user to know which products or services are estimated to be of interest and where they can be purchased. The business operator can actively guide the user to a product or a service that is estimated to be of interest and promote sales.

### [Sequence of Analysis Method]

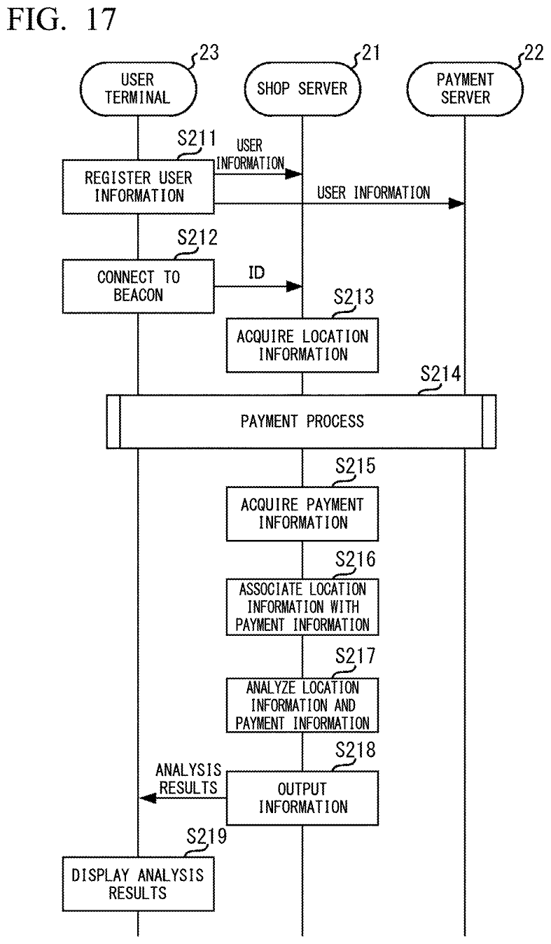

FIG. 17 is a sequence diagram of an analysis method executed by the analysis system 2S according to the second embodiment.

First, the user previously registers user information in the shop server 21 and the payment server 22 using the user terminal 23 (S211). The shop server 21 causes the user information storage unit 2123 to store the user information received from the user terminal 23. The payment server 22 causes the storage unit 222 to store the user information received from the user terminal 23.

The user terminal 23 is connected to one of the plurality of beacons 25 through short-range wireless communication and transmits the first ID stored in the storage unit of the user terminal 23 to the shop server 21 via the beacon 25 (S212). The location information acquisition unit 2111 of the shop server 21 periodically measures a location of the user terminal 23 on the basis of a location of the beacon 25 to which the user terminal 23 is connected. The location information acquisition unit 2111 acquires the measured location and a measurement time as location information and causes the location information storage unit 2121 to store the location information (S213).

Steps S212 to S213 of measuring the location of the user terminal 23 are iteratively performed. The shop server 21 performs the processing from step S214 when the payment using the user terminal 23 has been started.

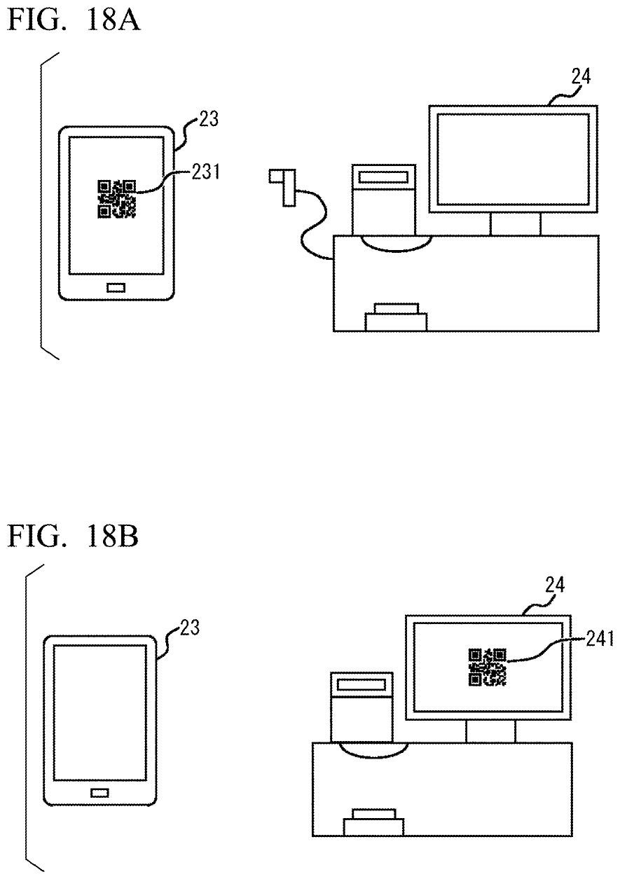

The user uses the user terminal 23 to perform payment of a product or a service of a purchase target in the shop terminal 24. The user terminal 23, the shop server 21, and the payment server 22 jointly perform a payment process (S214). Details of the payment process of step S214 will be described below with reference to FIGS. 18A and 18B to 21.

The payment information acquisition unit 2113 acquires a second ID and the amount of money of the payment received from the payment server 22 as payment results, a shop ID which is identification information for identifying the shop, and a name of the product or the service of the purchase target and causes the payment information storage unit 2122 to store them as payment information (S215).

The analysis unit 2114 acquires the location information stored in the location information storage unit 2121. Also, the analysis unit 2114 acquires the payment information stored in the payment information storage unit 2122. The analysis unit 2114 associates the location information with the payment information by associating the first ID of the location information with the second ID of the payment information on the basis of the association information stored in the user information storage unit 2123 (S216).

The analysis unit 2114 analyzes the location information and the payment information that have been associated (S217). For example, the analysis unit 2114 identifies an area inside the site 2P of the shop visited by the user on the basis of the location information and the payment information that have been associated and further estimates a product or a service in which the user is interested.

The output unit 2115 outputs the location information and the payment information associated by the analysis unit 2114 and outputs the analysis results of the analysis unit 2114 (S218). For example, the output unit 2115 causes the storage unit 212 to store the location information and the payment information associated by the analysis unit 2114 and the analysis results of the analysis unit 2114 and transmits the analysis results of the analysis unit 2114 to the user terminal 23. The user terminal 23 displays the analysis results of the analysis unit 2114 received from the shop server 21 on the display unit (S219).

### [Description of Payment Process]

In step S214 of FIG. 17, the user terminal 23 and the shop terminal 24 display and read a code, so that the payment process shown below is performed. FIGS. 18A and 18B are schematic views of the payment process executed by the analysis system 2S according to the second embodiment. FIG. 18A shows a payment process when the user terminal 23 displays a code 231. The code 231 is an image such as a bar code or a two-dimensional code and indicates at least code information associated with the second ID of the user terminal 23. The code information may indicate the second ID itself or may indicate a token or a password associated with the second ID. The code information is generated by the payment server 22 in association with the second ID on the basis of a request from the user terminal 23 and is transmitted to the user terminal 23. The user terminal 23 displays the code 231 on the basis of the code information.

The shop server 21 reads the code 231 using a camera or a scanner provided in the shop terminal 24 to acquire the code information indicated by the code 231 and transmits the acquired code information to the payment server 22 to cause the payment to be executed. The payment server 22 executes the payment when authentication has succeeded by collating previously generated code information with the code information received from the shop terminal 24.

FIG. 18B shows the payment process when the shop terminal 24 displays the code 241. In this case, the code 241 is an image such as a bar code or a two-dimensional code, and indicates at least the code information associated with the shop ID of the shop. The code information may indicate the shop ID itself or may indicate a token or password associated with the shop ID. Also, the code information may indicate the amount of money of the payment in addition to the shop ID. The code information is generated by the payment server 22 in association with the shop ID on the basis of a request from the shop terminal 24 and is transmitted to the shop terminal 24. The shop terminal 24 displays the code 241 on the basis of the code information.

The user terminal 23 reads the code 241 using the camera provided in the user terminal 23 to acquire the code information indicated by the code 241 and transmits the acquired code information to the payment server 22 together with the second ID to cause the payment to be executed. The payment server 22 collates the second ID and the code information, which have been received, with the second ID and the code information, which have previously been stored, and executes the payment when authentication has succeeded. Also, after the payment server 22 receives the second ID from the user terminal 23 before the camera is activated and authentication with the second ID which has previously been stored is performed, the payment server 22 may authenticate only the code information read from the shop terminal 24 by the user terminal 23 to execute payment when the user terminal 23 can activate the camera to read the code 241.

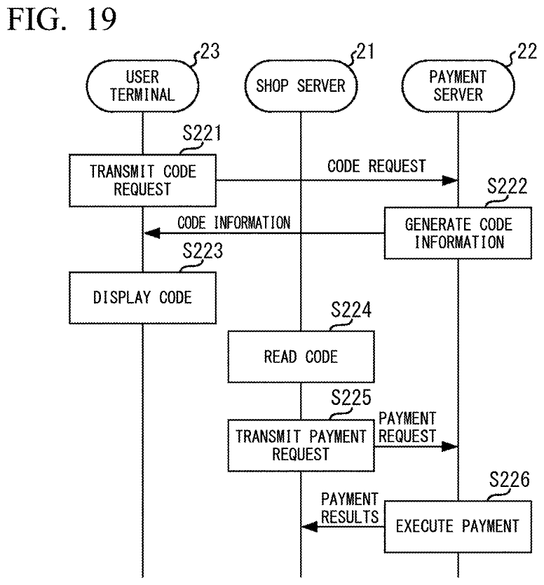

FIG. 19 is a sequence diagram of a payment process when the user terminal 23 displays the code 231. First, the user terminal 23 transmits a code request to the payment server 22 together with a second ID (S221). After the second ID received from the user terminal 23 is authenticated, the payment server 22 generates code information associated with the second ID and causes the storage unit 222 to store the code information (S222). The payment server 22 transmits the generated code information to the user terminal 23.

The user terminal 23 displays the code 231 on the display unit on the basis of the code information received from the payment server 22 (S223). In the shop server 21, the payment processing unit 2112 reads the code 231 using the camera or the scanner provided in the shop terminal 24 and acquires code information indicated by the code 231 (S224). The payment processing unit 2112 transmits a payment request indicating the acquired code information, the amount of money of the payment, and a shop ID to the payment server 22 (S225).

The payment server 22 executes the payment of the amount of money indicated by the payment request with respect to the user of the second ID on the basis of the payment request received from the shop server 21 (S226). The payment server 22 transmits payment results indicating the second ID, the amount of money of the payment, and the shop ID to the shop server 21.

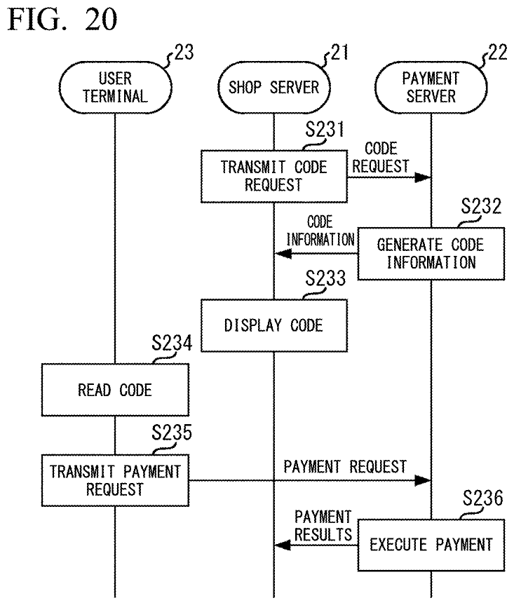

FIG. 20 is a sequence diagram of a payment process when the shop terminal 24 displays the code 241.

First, the shop server 21 transmits a code request to the payment server 22 together with a shop ID and the amount of money of payment (S231). After the shop ID received from the shop server 21 is authenticated, the payment server 22 generates code information associated with the shop ID and the amount of money of the payment and causes the storage unit 222 to store the code information (S232). The payment server 22 transmits the generated code information to the shop server 21.

The payment processing unit 2112 of the shop server 21 displays a code 241 on the display unit of the shop terminal 24 on the basis of the code information received from the payment server 22 (S233). The user terminal 23 reads the code 241 using the camera provided in the user terminal 23 and acquires the code information indicated by the code 241 (S234). The user terminal 23 transmits the payment request to the payment server 22 together with the acquired code information and the second ID (S235).

The payment server 22 executes the payment of the amount of money stored in the storage unit 222 with respect to the user of the second ID on the basis of the payment request received from the user terminal 23 (S236). The payment server 22 transmits payment results indicating the second ID, the amount of money of the payment, and the shop ID to the shop server 21.

The previously generated (i.e., static) code 241 may be displayed or posted in the shop. In this case, the code 241 indicates a prescribed amount of money and a shop ID. In the sequence of FIG. 20, steps S231 to S232 are omitted and the process from step S233 is performed in a similar manner.

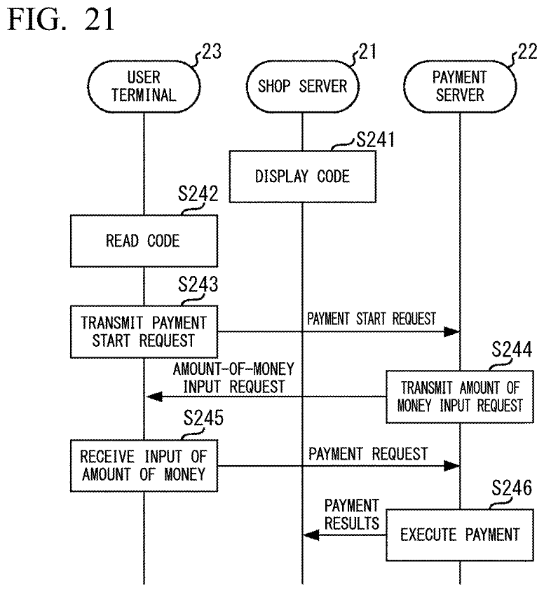

FIG. 21 is a sequence diagram of another payment process when the shop terminal 24 displays the code 241. The sequence of FIG. 21 is different from the sequence of FIG. 20 and the user inputs the amount of money of the payment using the user terminal 23. First, the shop server 21 displays the code 241 indicating a shop ID on the display unit of the shop terminal 24 (S241). The code 241 may be previously printed and posted inside the shop. The user terminal 23 reads the code 241 using the camera provided in the user terminal 23 and acquires the shop ID indicated by the code 241 (S242). The user terminal 23 transmits a payment start request indicating the acquired store ID and the second ID to the payment server 22 (S243).

The payment server 22 causes the storage unit 222 to store the shop ID and the second ID indicated by the payment start request received from the user terminal 23 and transmits the amount-of-money input request to the user terminal 23 (S244). When the amount-of-money input request has been received from the payment server 22, the user terminal 23 receives the input of the amount of money of the payment from the user (S245). The user inputs the amount of money of the payment to the user terminal 23 using a keyboard, a touch panel, or the like. The user terminal 23 transmits a payment request indicating the amount of money of the payment received from the user to the payment server 22.

The payment server 22 executes the payment of the amount of money indicated by the payment request received from the user terminal 23 with respect to the user of the second ID (S246). The payment server 22 transmits a payment result indicating the second ID, the amount of money of the payment, and the shop ID to the shop server 21.

### [Effects of Second Embodiment]

The analysis system 2S according to the second embodiment associates the first ID used for acquiring the location information of the user terminal 23 with the second ID used for payment using the user terminal 23. Thereby, the analysis system 2S can automatically associate the location information and the payment information of the user in the shop and can reduce the time and effort required to associate the location information with the payment information and analyze the location information and the payment information that have been associated.

Although the present invention has been described above using the embodiments, the technical scope of the present invention is not limited to the scope described in the above-described embodiments and various modifications and changes are possible within the scope of the subject matter thereof. For example, the specific embodiment of the distribution/integration of the devices is not limited to the above-described embodiment and all or a part thereof can be configured to be functionally or physically distributed/integrated in any unit. Also, a new embodiment produced by any combination of a plurality of embodiments is also included in the embodiment of the present invention. The effect of the new embodiment produced by the combination has the effect of the above-described embodiment.

Processors of the shop server 21, the payment server 22, and the user terminal 23 serve as main components for performing steps included in the analysis methods shown in FIGS. 17 and 19 to 21. That is, the processors of the shop server 21, the payment server 22, and the user terminal 23 execute the analysis methods shown in FIGS. 17 and 19 to 21 by reading a program for executing the analysis methods shown in FIGS. 17 and 19 to 21 from the storage unit and executing the program to control each part of the analysis system 2S. Some of the steps included in the analysis methods shown in FIGS. 17 and 19 to 21 may be omitted, the order between the steps may be changed, and a plurality of steps may be performed in parallel.

### REFERENCE SIGNS LIST

1S analysis system
11 Analysis server
111 Control unit
1111 In-site location information acquisition unit
1112 Off-site location information acquisition unit
1113 Analysis unit
1114 Output unit
12 Shop server
13 Communication terminal
15 Beacon
121 Control unit
1211 Location measurement unit
1212 Location transmission unit
2S Analysis system
21 Shop server
211 Control unit
2111 Location information acquisition unit
2112 Payment processing unit
2113 Payment information acquisition unit
2114 Analysis unit
2115 Output unit
212 Storage unit
23 User terminal
24 Shop terminal
25 Beacon

1. An analyzer comprising:
a first acquisition unit configured to acquire first location information indicating a location of a terminal that is measured when the terminal of a user is connected to a plurality of location measurement devices installed inside a prescribed site in association with in-site identification information for identifying the user or the terminal;
a second acquisition unit configured to acquire second location information indicating a location of the terminal measured in a measurement method different from that of the first location information outside the site in association with off-site identification information for identifying the user or the terminal;
an analysis unit configured to associate the first location information with the second location information by associating the in-site identification information with the off-site identification information and analyze the first location information and the second location information that have been associated; and
an output unit configured to output analysis results.

2. The analyzer according to claim 1, wherein the first acquisition unit is configured to acquire the first location information indicating the location of the terminal that is measured when the terminal is connected to a plurality of location measurement devices through short-range wireless communication.

3. The analyzer according to claim 1, wherein the first acquisition unit is configured to acquire a route along which the terminal has moved inside the site as the first location information.

4. The analyzer according to claim 1, wherein the second acquisition unit is configured to acquire a route along which the terminal has moved outside the site as the second location information.

5. The analyzer according to claim 1,
wherein the first acquisition unit is configured to acquire a location of the terminal inside the site and a time when the location has been measured as the first location information, and
wherein the second acquisition unit is configured to acquire a location of the terminal outside the site and a time when the location has been measured as the second location information.

6. The analyzer according to claim 1, wherein the analysis unit is configured to statistically analyze the first location information and the second location information of a plurality of users for each attribute of the plurality of users.

7. The analyzer according to claim 1,
wherein the analysis unit is configured to estimate a product or a service in which the user is interested on the basis of the first location information, and
wherein the output unit is configured to transmit information associated with the product or the service estimated by the analysis unit to the terminal.

8. The analyzer according to claim 1, wherein the first acquisition unit is configured to acquire the first location information indicating a location of the terminal inside the site including a plurality of shops.

9. The analyzer according to claim 8, wherein the first acquisition unit is configured to acquire the first location information indicating a location of the terminal that is measured when the terminal is connected to a plurality of location measurement devices installed within the plurality of shops or between shops.

10. The analyzer according to claim 1, wherein the analysis unit is configured to identify a site visited by the user outside the site on the basis of the second location information.

11. The analyzer according to claim 1, wherein the analysis unit is configured to statistically analyze information about a location where the user has stayed for a prescribed time period or longer on the basis of the second location information.

12. The analyzer according to claim 1, wherein the first acquisition unit is configured to acquire the in-site identification information that the location measurement device has acquired from the terminal by receiving the in-site identification information from the location measurement device.

13. An analysis method performed by a processor, comprising:
acquiring first location information indicating a location of a terminal that is measured when the terminal of a user is connected to a plurality of location measurement devices installed inside a prescribed site in association with in-site identification information for identifying the user or the terminal;
acquiring second location information indicating a location of the terminal measured in a measurement method different from that of the first location information outside the site in association with off-site identification information for identifying the user or the terminal;
associating the first location information with the second location information by associating the in-site identification information with the off-site identification information and analyzing the first location information and the second location information that have been associated; and
outputting analysis results.

14. An information processing device comprising:
a location information acquisition unit configured to acquire location information indicating a location of a user terminal that is measured when the user terminal owned by a user is connected to a plurality of location measurement devices installed inside a prescribed site including a shop in association with first identification information for identifying the user or the user terminal;
a payment information acquisition unit configured to acquire payment information indicating content of payment processed in association with second identification information for identifying the user or the user terminal in the shop and performed by the user using the user terminal; and
an output unit configured to output information generated by associating the location information with the payment information when the first identification information associated with the location information is associated with the second identification information associated with the payment information.

15. The information processing device according to claim 14, wherein the payment information acquisition unit is configured to acquire the payment information indicating the content of the payment performed by reading a code indicating information associated with the second identification information displayed by the user terminal using a shop terminal installed in the shop.

16. The information processing device according to claim 14, further comprising a payment processing unit configured to cause a display unit of a shop terminal installed in the shop to display a code indicating information associated with the shop or the payment,
wherein the payment information acquisition unit is configured to acquire the payment information indicating the content of the payment performed by the user terminal reading a code indicating information associated with the shop or the payment.

17. The information processing device according to claim 14, wherein, when the first identification information associated with the location information is the same as the second identification information associated with the payment information or when the first identification information associated with the location information is associated with the second identification information associated with the payment information in a storage unit, the output unit is configured to output information generated by associating the location information with the payment information.

18. The information processing device according to claim 17, wherein the output unit is configured to acquire the first identification information associated with the second identification information in the storage unit after acquiring the second identification information associated with the payment information and associates the location information associated with the first identification information that has been acquired with the payment information associated with the second identification information that has been acquired.

19. The information processing device according to claim 14, wherein the location information acquisition unit is configured to acquire a location of the user terminal inside the site and a time when the location has been measured as the location information.

20. The information processing device according to claim 14, further comprising an analysis unit configured to estimate a product or a service in which the user is interested on the basis of the location information and the payment information,
wherein the output unit is configured to transmit information associated with the product or the service estimated by the analysis unit to the user terminal.

21.-26. (canceled)
